(19) United States
(12) Patent Application Publication
(10) Pub. No.: US 2016/0207207 A1
(43) Pub. Date: Jul. 21, 2016

(54) FOLDING ASSEMBLIES WITH LOCKING MECHANISM

(71) Applicant: FirstEdge, LLC, Orinda, CA (US)

(72) Inventors: Wesley James Tom, Vista, CA (US); Brett Philip Seber, Vista, CA (US)

(73) Assignee: FirstEdge, LLC

(21) Appl. No.: 15/000,699

(22) Filed: Jan. 19, 2016

Related U.S. Application Data
(60) Provisional application No. 62/105,606, filed on Jan. 20, 2015.

(51) Int. Cl. B26B 1/04

(52) U.S. Cl. CPC B26B 1/044

(57) ABSTRACT

A folding assembly includes a tool pivotally connected to a handle and movable between a closed position in which the tool extends along the handle and an open position in which a free end of the tool extends away from the handle. A manually actuated locking mechanism includes a locking pin extending axially through an elongated slot of the tool and into a track of the handle. A spring is disposed within the elongated slot of the tool that biases the locking pin away from the free end of the tool. A portion of the locking pin travels a length of the track as the tool is moved between the closed and open positions.

### RELATED APPLICATION

This application claims priority from U.S. Provisional Application No. 62/105,606, filed Jan. 20, 2015.

### BACKGROUND OF THE INVENTION

The present invention generally relates to folding assemblies, such as folding knives and hand tools. More particularly, folding assemblies as disclosed herein relate to assemblies having one member that is pivotably attached to another member, and that incorporates a locking mechanism therein for purpose of fixing the location of one member relative to the other, e.g., in an open and/or closed position.

Folding assemblies incorporating locking mechanisms are known in the art. An example of such folding assemblies are folding knives having one member in the form of a blade that is pivotably attached to another member in the form of a handle, and that may be manually operated to move the blade from a closed position disposed within the handle for storage to an open position exposed from the handle for use. Such known folding assemblies in the form of folding knives include a locking mechanism to keep the blade member in an open locked position during use. The conventional locking mechanism used in such folding knives is provided in one of two forms, that of a linerlock gate system or linerback rocker system.

The linerlock gate system is one that makes use of a biased gate member that is disposed within the knife between the handles and that extends generally parallel with the handles. As the knife is unfolded from its closed position within the handle to a position approaching an opened position the gate member snaps by bias force into place against a backside edge or butt of the knife to lock the blade member into an opened position. The blade member is released from its locked open position by manually urging the gate member away from engagement of the blade member backside edge. A shortcoming of such linerlock gate system is that the locked engagement between the blade backside edge and the gate member may become disengaged during use of the knife in situations where the blade has too much force applied in the wrong direction causing the blade member to bend relative to the handles. Such bending of the blade member is known to cause the gate member to disengage the blade member, unintentionally causing the blade member to become unlocked, which can both present an unsafe situation for the user and/or render the knife unusable.

The linerback rocker system is one that makes use of a biased rocker element that is disposed within the knife between the handles along a top surface of the knife generally parallel with the handles. As a user extends the knife member from its closed position disposed within the handles, a backside edge of the blade member slides long the biased rocker element causing the rocker element to move upwardly until the blade member is moved to an open position where the rocker element registers with a surface portion of the knife blade to lock the knife blade into the open position. The blade member is released from its locked position by manually pressing on a rear section of the rocker element to raise a front section of the rocker element to disengage it with the surface section of the blade member. A shortcoming of such linerback rocker system is that the locked engagement between the blade surface portion and the rocker member may become disengaged during use of the knife in situations where the rear section of the rocker element is contacted by an object during use, e.g., to assist in a cutting activity or the like, unintentionally causing the blade member to become unlocked, which can both present an unsafe situation for the user and/or render the knife unusable.

It is, therefore, desired that a folding assembly comprising two members pivotably attached to one another be constructed in a manner having an improved locking mechanism that reduces or eliminates situations where during use one of the members becomes unintentionally unlocked, thereby extending the safety and reliability of the folding assembly during use, and extending the service life of the folding assembly. It is also desired that folding assemblies comprising such improved locking mechanism be adapted to accommodate manual activation of one member from a closed to an open position relative to the other member, or assisted activation of the one member from a closed to an open position relative to the other member in a manner that is relatively easy to operate, safe and reliable. The present invention fulfills these needs, and provides other related advantages.

### SUMMARY OF THE INVENTION

The present invention generally relates to folding assemblies having one member, such as a handle, that is pivotally attached to another member, such as a tool, and that incorporates a locking mechanism for fixing the location of the members relative to one another. The locking mechanism of the present invention reduces or eliminates situations where during use one of the members becomes unintentionally unlocked. The locking mechanisms of the folding assemblies herein are also adapted to accommodate manual activation, or assisted activation, of one member from a closed to an open position relative to the other member in a manner that is relatively easy to operate, safe and reliable.

A folding assembly in accordance with the present invention generally comprises a tool pivotally connected to a handle and movable between a closed position in which the tool extends along the handle and an open position in which a free end of the tool extends away from the handle. The folding assembly may comprise a folding knife, with the tool comprising a blade, although other hand tools and folding assemblies are contemplated by the present invention.

A manually actuated locking pin extends axially through an elongated slot formed in the tool and into a track of the handle. A portion of the locking pin travels a length of the track as the tool is moved between the closed and open positions.

The handle may comprise first and second grips, having first and second liners disposed between the grips in spaced relation on opposite sides of the tool when in the closed position. The track is formed in at least one of the first and second grips and at least one of the first and second liners. The track may be generally disposed radially from a pivotal connection point of the tool and handle. A first end of the track comprises a first lock position when the locking pin is disposed therein. The locking pin extends from an aperture of the handle when the locking pin is moved to a locking position in the track. The handle may include an external recess adjacent to the aperture through which the locking pin extends.

A spring is disposed within the elongated slot of the tool for biasing the locking pin away from the free end of the tool. The spring is disposed within the slot generally transverse to the locking pin. The spring typically comprises a compression spring, and may include a guide pin disposed within the slot and the compression spring so as to be biased by the spring against the locking pin.

A generally opposite second end of the track may comprise a second lock position when the locking pin is disposed therein. The locking pin locks the tool in the open position when in the first lock position, and locks the tool in the closed position when in the second lock position. The locking pin extends from a second aperture of the handle when the locking pin is moved to the second locked position.

The folding assembly may include a mechanism for assisting in the opening or closing of the tool. The assisting mechanism may comprise a spring fixed at one end of the tool and another end to the handle. The spring may comprise a coil spring, which is disposed within an internal recess of the grip of the handle, having one end connected to the handle and a generally opposite end extending through a channel formed in a liner of the handle and connected to the tool.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIGS. 1A and 1B are side perspective views illustrating folding assemblies with locking mechanisms as disclosed herein embodied in the form of first and second folding knives in open locked positions;

FIG. 2 is a side perspective view illustrating a first example folding knife as disclosed herein;

FIG. 3 is a topside exploded view illustrating the first example folding knife of FIG. 2;

FIG. 4 is an underside exploded view illustrating the first example folding knife of FIG. 2;

FIG. 5 is another exploded view illustrating the first example folding knife of FIG. 2;

FIGS. 6A to 6C are section views illustrating a spring and locking/release pin as disposed in an elongate opening through a blade member of the first example folding knife of FIG. 1A, and the locking/release pin as disposed in channel openings through liners when the blade member is in a locked open position and in a closed position;

FIG. 7 is a side view of the first example folding knife in a closed position;

FIG. 8 is a side perspective view illustrating a second example folding knife as disclosed herein;

FIG. 9 is a topside exploded view illustrating the second example folding knife of FIG. 8;

FIG. 10 is an underside exploded view illustrating the second example folding knife of FIG. 8;

FIG. 11 is another exploded view illustrating the second example folding knife of FIG. 8;

FIG. 12 is a side view illustrating an inner surface of a grip of the second example folding knife of FIG. 8;

FIGS. 13A and 13B are section views illustrating a locking/release pin as disposed in channel openings through liners when a blade member is in a locked open position and in a closed position of the second example folding knife of FIG. 1B;

FIG. 14 is a side view of the second example folding knife in a closed position; and

FIG. 15 is a side view of an example folding knife as disclosed herein including an attachment clip.

### DETAILED DESCRIPTION OF THE PREFERRED EMBODIMENTS

As shown in the accompanying drawings, for purposes of illustration, the present invention resides in folding assemblies having one member that is pivotally attached to another member, and incorporating a locking mechanism for fixing the location of the one member relative to the other, such as in an open and/or closed position.

Generally, folding assemblies with locking mechanisms as disclosed herein comprise first and second members that are pivotably attached to one another and include an improved locking mechanism when contrasted to conventional folding assemblies with locking mechanisms such as those described above known in the art. More specifically, folding assemblies and locking mechanisms as disclosed herein comprise a first member that is pivotably attached to a second member, wherein the first member is interposed between a pair of liners that are part of the second member. Each of the liners are specially configured to accommodate and enable rotational movement of a locking/release pin disposed through a portion of the first member as the first member is rotated between one position, e.g., a closed position, and another position, e.g., an open position relative to the second member and liners. Each of the liners is further configured to accommodate placement of a stop element or pin therein. The locking/release pin is thus disposed through the first member and is placed in double shear by fitment at opposed end through a respective liner to thereby ensure a robust and maintained locked engagement of the first member relative to the second member. The stop element operates to restrict travel of the first member of the first blade member beyond that permitted by cooperation of the locking/release pin member with a specific section of the liners.

Folding assemblies comprising such improved locking mechanisms as disclosed herein comprise first members in the form of a tool that may be configured differently to perform a variety of different functions depending on the particular end-use application, while the second member may be a handle configured to hold the folding assembly stationary relative to the first member during and/or after rotational pivoting movement of the first folding member relative to the second member. Nonlimiting examples of first member tool configurations may be in the form of a knife blade, saw blade, tool blade or element, and the like. In an example, the folding assemblies and locking mechanisms as disclosed herein may be configured to enable movement, e.g., opening, of the first member relative to the second member by manual means, e.g., by a user manually engaging a portion of the first member knife and pivotably moving it relative to the second member. In an example, the folding assemblies and locking mechanisms as disclosed herein may be configured to provide assisted movement of the first member, e.g., by a user engaging a release element of the locking mechanism, to thereby enable the first member to move from a closed position to an open position automatically, e.g., without further user interaction. Further details regarding such folding assemblies and locking mechanisms as disclosed herein and their constructions are provided below with reference to certain example embodiments.

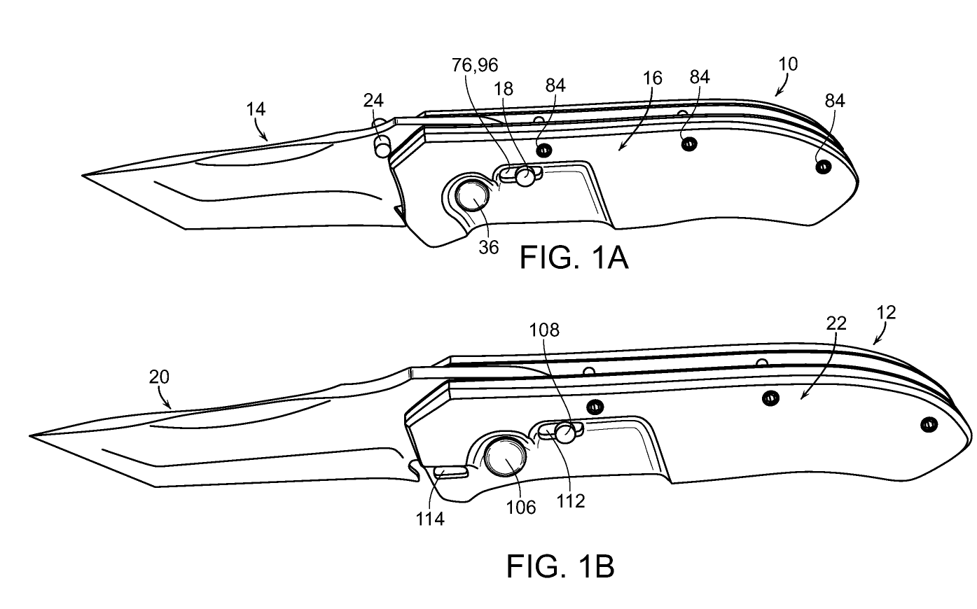

FIGS. 1A and 1B illustrate first and second example folding assemblies and locking mechanisms as disclosed herein embodied in the form of folding knives 10 and 12, respectively. Such embodiments of folding assemblies and locking mechanisms as disclosed herein are provided for purpose of reference for describing and illustrating the components and function of such folding assemblies and locking mechanisms, and it is to be understood that folding assemblies and locking mechanisms as disclosed herein may be embodied in a variety of different embodiments which all embody the principles of the concept and are within the scope of the concept as disposed herein.

With reference to the embodiment illustrated in FIG. 1A, the first example folding knife 10 generally comprises a first member in the form of a blade 14 (shown in an open position) that is pivotably rotatably attached with a second member in the form of a housing or handle 16. The first example folding knife 10 is configured for manual movement of the blade 14 from a closed to open position and vice versa. Such manual movement can be achieved by a user's contact with a pin 17 disposed through the blade 14 and located near a top portion of the blade, e.g., away from the sharpened edge. The first example folding knife 10 includes a locking/release pin 18 that is disposed through an opening of the handle 16 for easy user access.

With reference to FIG. 1B, the second example folding knife 12 similarly comprises a first member in the form of a blade 20 (shown in an open position) that is pivotably rotatably attached with a second member in the form of a housing or handle 22. The second example folding knife 12 is configured for assisted movement of the blade 20 from a closed to an open position. Such assisted movement can be achieved through the use of an assist mechanism comprising an assist element, such as a spring or the like, disposed within the knife (as described in greater detail below). The second example folding knife includes a locking/release pin 108 that is disposed through an opening 112 of the handle 22 for easy user access.

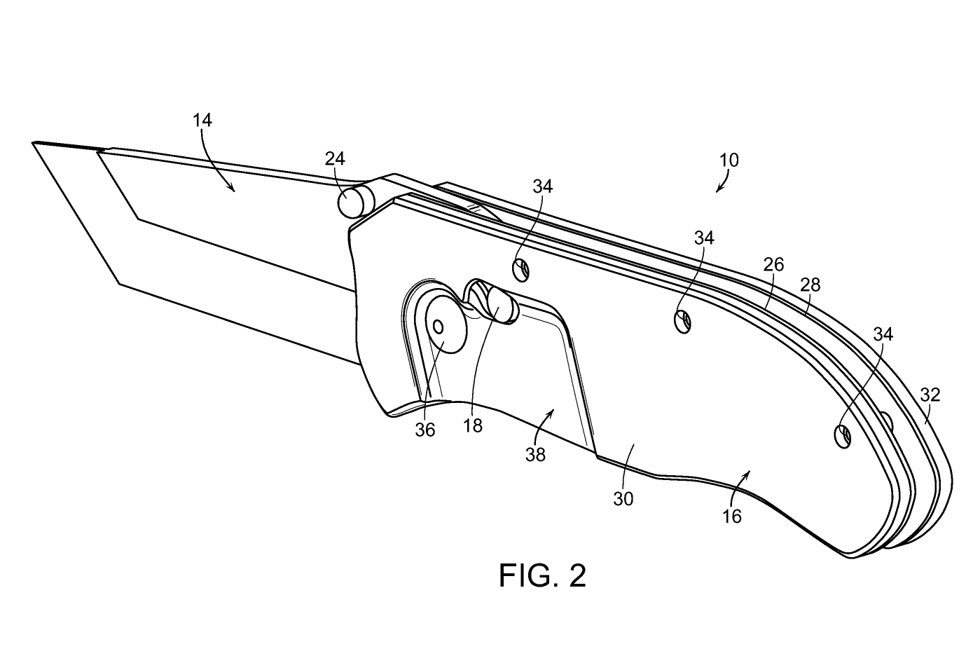

FIG. 2 illustrates the first example folding knife 10 in an opened position comprising the blade 14 and the handle 16. The handle 16 comprises a pair of liners 26 and 28 that are part of the locking mechanism and that are positioned on opposite surfaces of the blade 14, sandwiching the blade 14 therebetween. Grips 30 and 32 are attached to an outer surface of each respective liner and may have an outer surface that is smooth, textured or otherwise configured to meet the needs of a particular end-use application. In an example, the grips have an outside surface that is textured to provide a desired degree of slip resistance during use. The grips and liners are attached to one another through the use of fastening elements such, as by screws, rivets or the like that may extend through openings 34 that exist through the grips and liners. A main or pivot pin 36 is disposed axially through the handle 16 and the blade 14 and operates to connect the blade to the housing and permit pivoting rotatable movement of the blade relative to the housing. The grip 30 is configured having a recessed section 38, and the main pin 36 as well as the locking/release pin 18 is located within the recessed section. The recessed section operates to position the locking/release pin 18 beneath the surface level of the remaining grip outer surface, so as to avoid unintentional contact and/or activation of the locking/release pin 18 during use of the knife in an open position. Additionally, the recessed section may operate to provide a location for a user's thumb so as to enhance the grip on the knife during use.

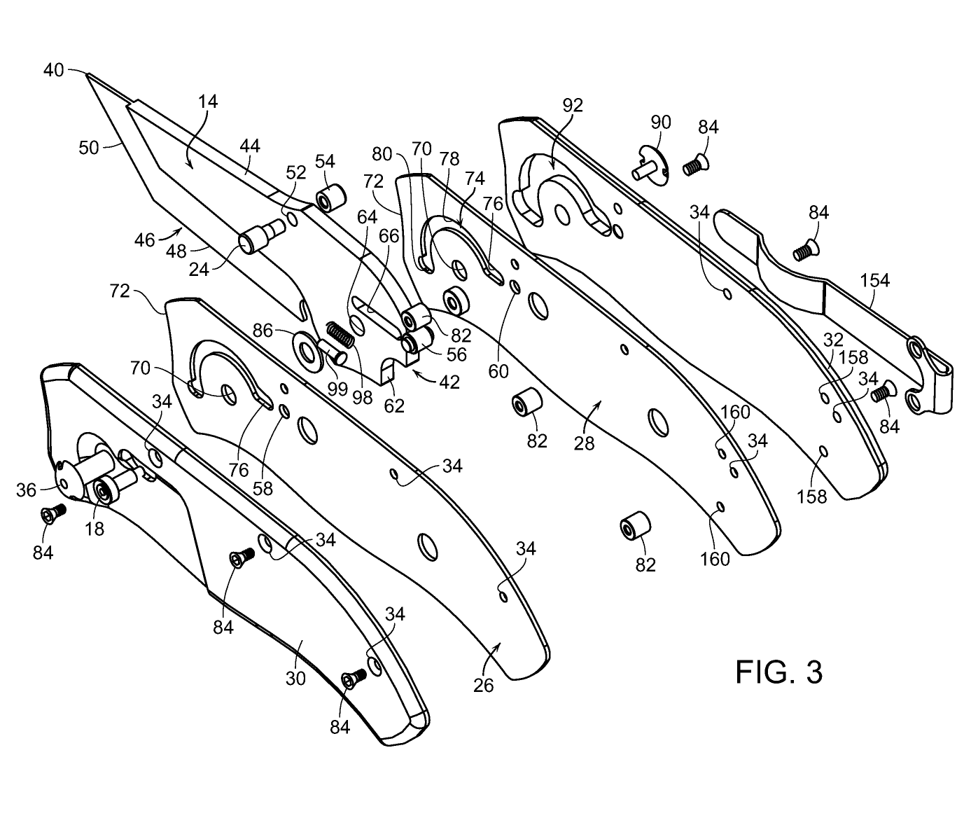

FIGS. 3 to 5 illustrate the first example knife 10 as disclosed herein in a disassembled state showing the various elements and members used to construct the folding knife 10 and the locking mechanism, including those described above and illustrated in FIG. 2. The blade 14 is made from a metallic material, an in a preferred example is made from hardened metal, and alloy metal such as stainless steel or the like, and combinations thereof. In an example, the blade is made from Elmax and has a Rockwell C Hardness (HRC) of greater than about 60. The blade 14 has a length that extends from a tip 40 to a base or butt 42, and has a top edge surface 44 and a bottom edge surface 46. In an example, the bottom edge surface 46 is a sharpened cutting surface, wherein the cutting surface extends along a first section 48 extending forward a distance from the butt 42 to a second section 50 that is at an upward angle of about 45 degrees from relative to the first section and that extends to the tip 40. In an example, the first and second sections forming the cutting surfaces are formed by grinding on each opposed side of the blade 14, e.g., providing a Tanto Blade by grinding on both sides using a flat grinding method. The thickness of the blade as measured along the thickest region of the blade, e.g., adjacent a region of the blade where the main pin 36 extends therethrough has a thickness of about 3.35 mm in a particular embodiment. The surface of the blade may be coated or otherwise treated to provide a desired finish and/or texture and/or protective barrier for a variety of different purposes depending on the particular end-use applications. In an example, the blade is treated to have a black oxide coating to provide a desired degree of corrosion resistance. Again, the blade is but one example configuration of the folding assembly first member tool provided for reference, and many other first member configurations are understood to be within the scope of the concept disclosed herein.

A thumb stud or pin 24 is disposed in an opening 52 through the blade 14 adjacent the top edge 44 at a location along the blade length making it practical for a user to contact with their finger to open and close the blade. In an example the pin 24 is secured to the blade though a fastened attachment such as a screwed attachment with a nut 54.

The blade butt 42 includes a section that is configured to make contact with a stop element or pin 56 that is interposed between the liners 26 and 28, and that forms part of the locking mechanism. In an example, the stop element 56 is secured in place with relative to the liners 26 and 28 through the placement of outer ends of the stop element within respective openings 58 and 60 through the liners. The stop element is formed from a metallic material, and in an example is formed from hardened steel having an HRC of greater than about 50, and about 58 to 60. The blade butt section 42 contacts the stop element to thereby limit the upward movement of the blade in an open position, which coincides with a locked open position provided by the locking mechanism. The blade butt 42 further includes a recessed section 62 to enable the blade to be rotated from an open to closed position and vice versa without contacting the stop element.

The blade includes a main opening 64 extending through the blade adjacent the butt for accommodating placement of the main pin 36 axially therethrough. The main pin 36 is formed from a metallic material, and in an example is formed from hardened steel having an HRC of greater than about 50, and about 58 to 60. The blade includes an elongate slot opening 66 extending therethrough running in a longitudinal direction parallel with an axis running from the butt 42 to the tip 40. The elongate slot opening 66 is adjacent the butt 42 and is configured to accommodate the locking/release pin 18 therein that is part of the locking mechanism, and to permit movement of the pin 18 longitudinally within the opening so as to enable the pin to provide release and locking operation (as explained in greater detail below). The blade 14 further includes a recessed groove 68 that is configured to enable the blade to be placed in a closed position within the handle clear of contacting the stop element 56.

The liners 26 and 28 are each provided in the form of a flat plate made from a structurally rigid material, such as a metallic material. In an example, the liners are formed from a stainless steel having an HRC greater than about 50. In an example, the liners are formed from 440A stainless steel having an HRC of about 58, and have a thickness of about 1.02 mm in a particular example. The thickness may be greater or less depending on the load factor imposed thereon by the first member or blade, so as to provide a desired shear force resistance to so as to ensure a robust locking mechanism. The liners each comprise a main opening 70 extending axially therethrough that is positioned adjacent a front edge 72 of each liner, and that is configured to register with the main opening 64 through the blade to accommodate passage of the main or pivot pin 36 therethrough. In an example, the blade is connected with the liners so that the liners enclose a desired length of the blade, which may be referred to as the hub, when placed in an open position that is at least 15 percent, from about 20 to 45 percent, from about 25 to 35 percent, and in an example approximately 30 percent of the total blade length.

The liners 26 and 28 each comprise a channel or track opening 74 that is disposed radially around an outside perimeter of the main opening 70, and that are configured as part of the locking mechanism. In an example, each of the channel track openings 74 are configured, moving from a rear of the liner to the front 72, having a first section 76 that is elongate extending from a closed end along an axis parallel with a length of the liner. The first section extends to a second section 78 configured in the form of an arc defined by a radius of curvature from the main opening 70. In an example, the second section 78 forms a segment of a circle sufficient to facilitate travel of the locking/release pin 18 therein during pivoting rotation of the blade between an open and closed position relative to the liners. In an example, the second section 78 comprises between about 90 to 240 degrees of a circle, between about 110 to 200 degrees of a circle, and approximately 180 degrees in a particular application. The second section 78 extends to a third section 80 that is elongate extending toward the front 72 of the liners from the second section to a closed end. In an example, the channel track openings have a width sufficient to accommodate sliding travel of the locking/release pin therein.

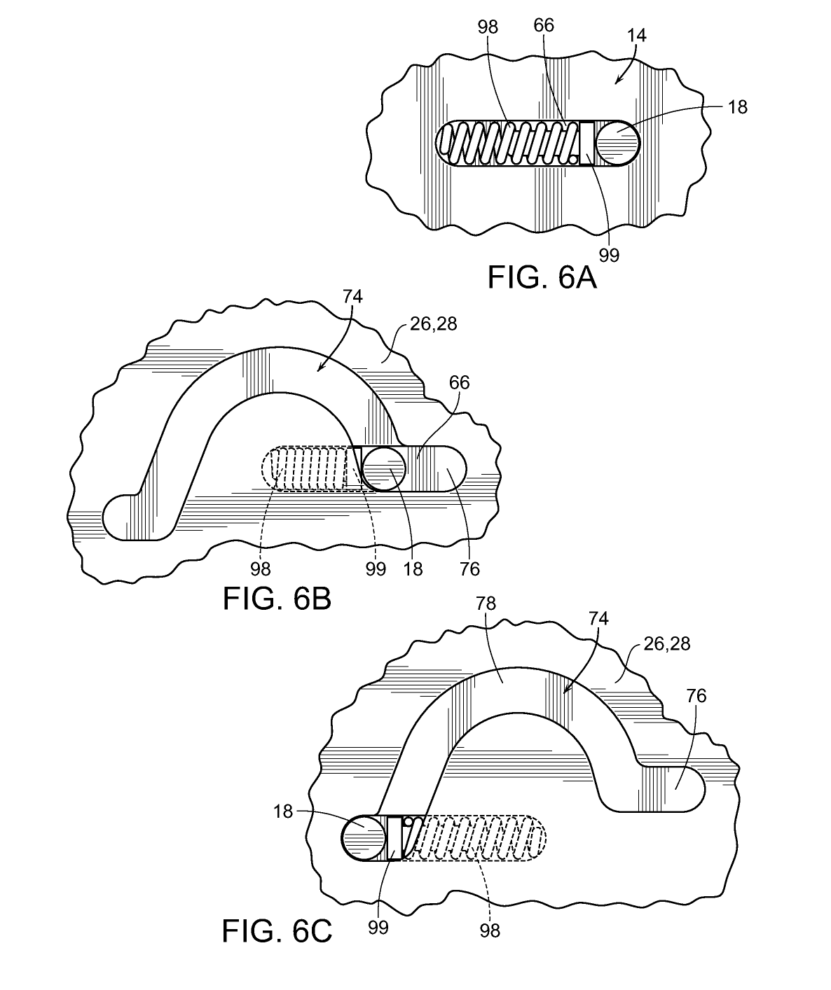

In an example, the first section 76 operates to accommodate placement of the locking/release pin 18 therein to place the blade in a locked open position, wherein the pin 18 is positioned within the first section adjacent the closed end. In this manner, the first member is fixed in a locked open position by the locking mechanism. For purposes of ensuring engagement, guidance and placement of the locking/release pin 18 in the first section 76 such first section may be configured having a tapered width at the transition with the second section, wherein the width at such transition is greater than the width approaching the closed end. In an example, the taper angle can be from about 1 to 10 degrees, 2 to 8 degrees, and in an example approximately 5 degrees. The length of the first section 76 is sufficient to capture the entire diameter of the locking/release pin 18 therein. In an example, the first section 76 may have a length that is from about 100 to 300 percent, about 110 to 200 percent, in an example approximately 125 percent of the locking/release pin 17 diameter. The fit of the locking/release pin 18 within the channel opening first section 76 is desired to enable a user to unlock the blade from an open position by sliding the locking/release pin 18 forward by finger, e.g., thumb, contact and activation. As disclosed below, a spring 98, and if desired a guide pin 99, is disposed within the blade member 66 elongate opening and operates to impose a spring force on the locking/release pin 18 biasing it towards the butt 42 (as best illustrated in FIG. 6A).

In an example, the third section 80 operates to accommodate at least partial placement of the locking/release pin 18 therein when the blade is placed into a closed position. Because the first example folding knife is one where the blade is manually moved/pivoted from a closed to an open position, e.g., by a user moving the blade by thumb contact with the pin 24, it is desired that the third section 80 be configured in a manner to enable the locking/release pin 18 to move outwardly therefrom without directly contacting the locking/release pin 18, as the pin is covered by the grip 30 when the blade is moved from the locked open position. In an example, the third section may have a length that is less than the diameter of the locking/release pin 18 and/or be configured having a tapered width that enables registration and easy inward and outward movement of the locking/release pin 18 therefrom. Thus, the locking mechanism configured as disclosed herein provides both a locked open placement of the blade relative to the housing, that must be released by user engagement and activation of the locking/release pin, and a closed placement of the blade that may be released by user movement of the blade.

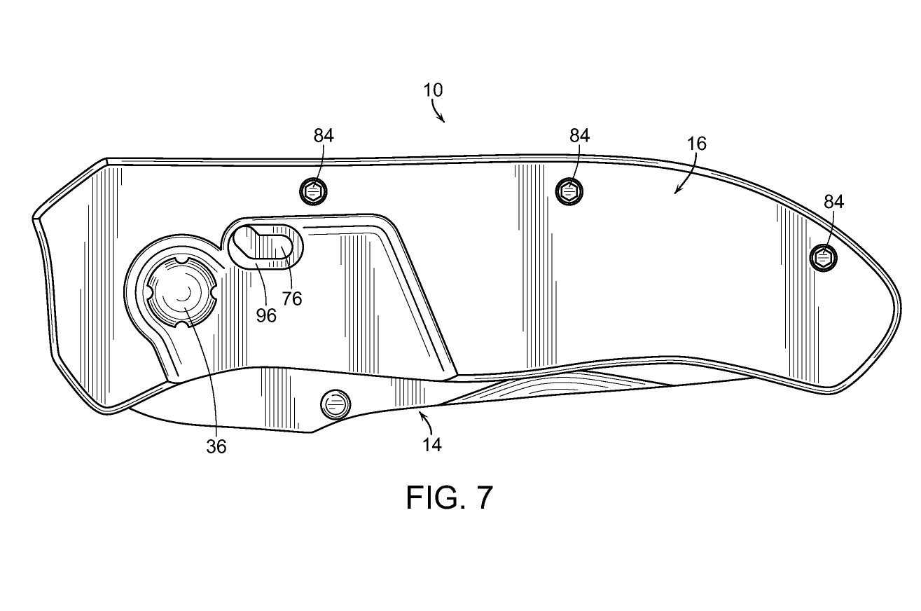

Spacers 82 are interposed between the liners 26 and 28 and operate to provide a desired distance or spacing between and along a length of the liners that is sufficient to enable unbinding movement of the blade member 14 when pivoted from a closed to open position. In an example, the folding knife comprise three spacers 82 that are each made from a structurally rigid material. In an example, the spacers 82 are formed from a metallic material that may be the same or different from the metal disclosed above for making the stop element 56. In an example, the spacers are round, have an axial thickness slightly greater than that of the blade, and each have a central opening extending axially therethrough that is threaded to accommodate mounting screws 84 therein (as best illustrated in FIGS. 1 and 7). In an example, the mounting screws 84 may have a hex head or other configuration, and a total of six mounting screws are used, wherein three are used to attach the grip 30 and liner 26 via the spacers, and three are used on the opposite surface of the knife to attach the grip 32 and liner 28 via the spacers. Washers 86 are interposed between the blade 14 and each of the liners 26 and 28 around the blade main opening 64 to accommodate passage of the main pin 36 therethrough. In an example, the washers may be made from a polymeric and/or metallic material, and may operate to provide eased rotational movement of the blade relative to the liners. In an example, the washers have a thickness of about 0.63 mm, and are formed from brass or bronze and provide a bearing surface for the blade.

The grips 30 and 32 may be formed from a structurally rigid material. Suitable materials include wood, polymeric materials, composite materials, metallic materials, and combinations thereof. In an example, the grips are formed from a hard polymeric material such as composite epoxy-fiber material. The outside surface of the grips may be smooth or textured. Each of the grips 30 and 32 include a main opening 88 passing therethrough for accommodating passage of the main pin 36 for attaching the respective grips and liners to the blade 14. The main pin 36 may include a mating element 90 on the opposite side of the knife that registers with the pin 36 to facilitate a fastened, e.g., threaded or otherwise, attachment therebetween. The main pin 38 and the locking/release pin 18 are each formed from a metallic material, and in an example the main pin 36 may be formed from stainless steel, and the locking/release pin 18 may be formed from stainless steel both having a HRC that is approximately the same as the liners, e.g., 58.

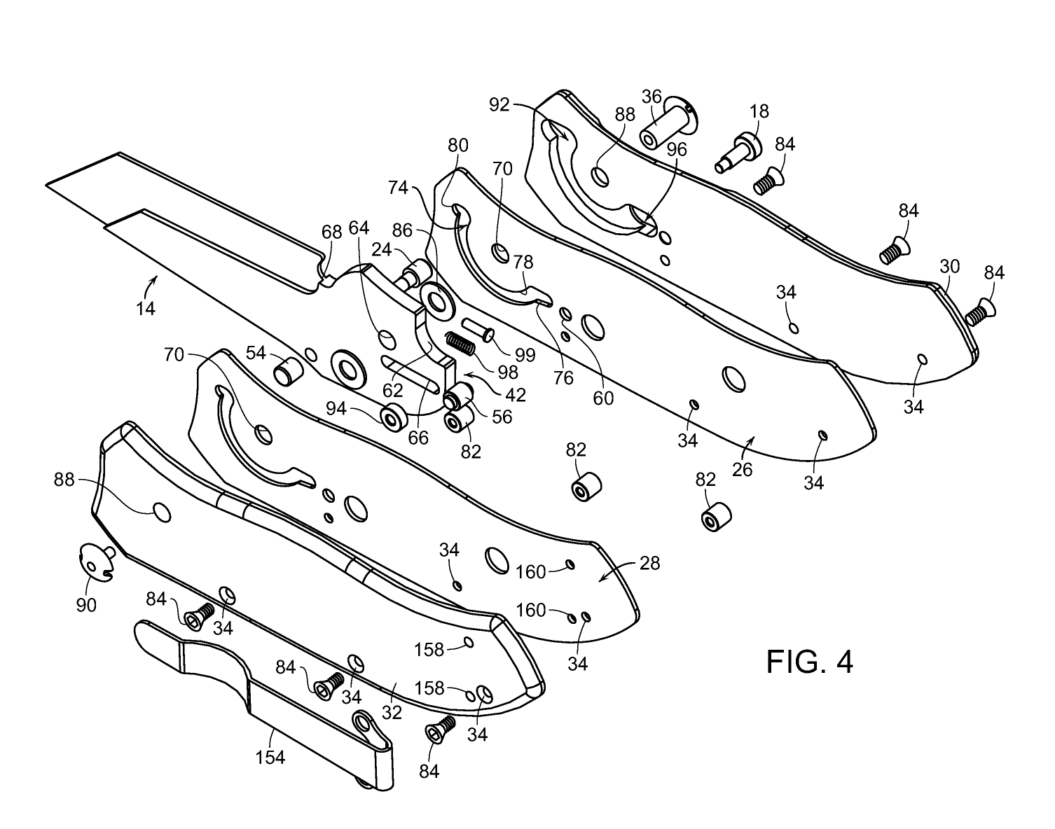

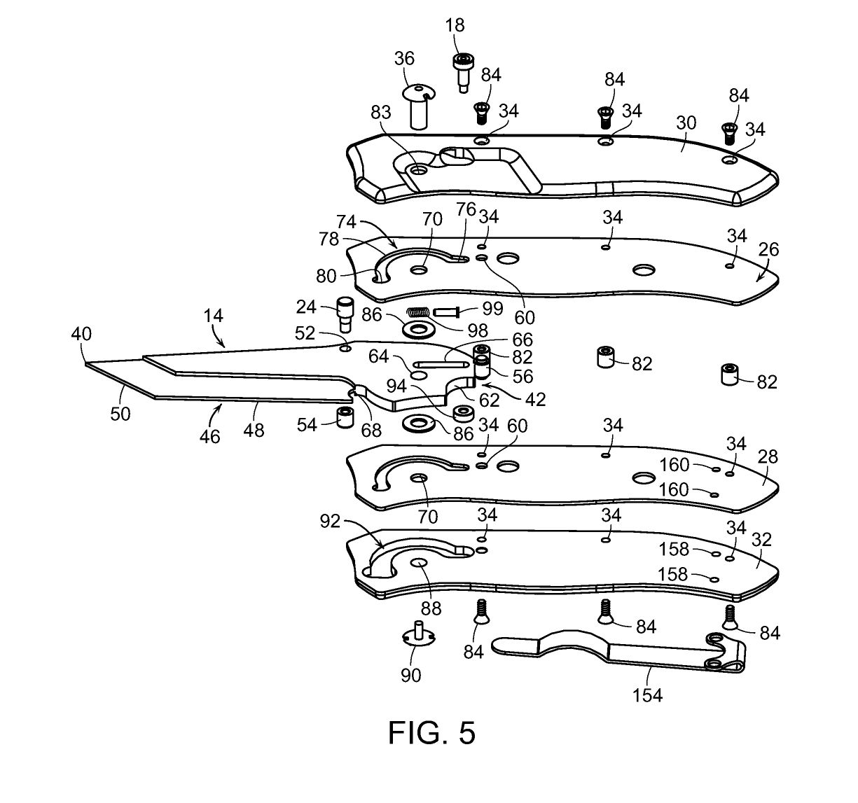

Each of the grips 30 and 32 have, along an inside surface adjacent a respective liner 26 and 28, a recessed track channel 92 that is configured similar to the channel track opening 74 in an adjacent liner. The recessed track channels 92 thus comprise first, second and third sections as disclosed above for the liner channel track openings, and are provided to accommodate movement of either the locking/release pin 18 therein, or movement of a mating end or cap 94 therein (best shown in FIG. 5) that may be threaded or otherwise attached to an and of the pin 18. The recessed channel 92 in grip 30 is configured having an opening 96 (best shown in FIGS. 4 and 5) through the grip along a first section to enable a head of the locking/release pin 18 to be exposed therethrough when the blade 14 is in an locked open position, thereby providing user access to a component of the locking mechanism. The recessed channels 92 are sized to accommodate movement of the locking/release pin 18 head therein in grip 30, and the movement of the locking/release pin cap 94 therein in grip 32 when the blade is moved between open and closed positions. Generally, the recessed channels are sized having a larger width than the channel openings in the liner to accommodate movement of the pin head and cap there, which are larger in diameter than the pin shaft that is placed within the liner channel openings.

The folding knife 10 is assembled by combining the above-described elements together as illustrated in FIGS. 3 to 5. In an example, the knife can be assembled by placing the spring 98 and guide pin 99 within the elongate opening 66 of the blade 14 (with reference to FIG. 6A) and sandwiching the blade 14, washers 86, stop element 56 and spacers 82 between the liners 26 and 28 in each of their designated positions, placing the locking/release pin 18 through the channel openings 74 in the liners 26 and 28 and through the blade elongate opening ensuring that the spring operates to bias the locking/release pin 18 towards the butt 42 as described above. If desired, pin 99 may be placed within the spring 98 so as to maintain desired spring alignment, and minimize any spring deflection, in the elongate opening. As shown in FIG. 6A, the spring 98 and pin 99 have longitudinal axes that are generally transverse to the elongated axis of the locking/release pin 18, and serve to bias the pin 18 towards a butt 42 of the blade 14. The cap 94 may be attached to the opposite side of the pin 18. The grips 30 and 32 are then placed over the respective liners 26 and 28, and the main pin 36 is disposed through the main openings of the grips, liners and blade and is secured an opposite end by the mating element 90. Mounting screws 84 are next disposed through the openings 34 in the grips and liners and are fastened to the spacers 82 to secure the handle assembly.

FIGS. 6B and 6C illustrate the position of the locking mechanism components when the first member is in different positioned, e.g., an open position and a closed position. Specifically, illustrate the position of the locking/release pin 18 within the channel track openings 74 of the liners 26 and 28 when the blade is in an open locked position (FIG. 6B) and in a closed position (FIG. 6C). Specifically, FIG. 6B illustrates the position of the locking/release pin 18 within the channel openings 74 of the liners 26 and 28 as being biased by the spring 98 and pin 99 disposed in the blade elongated opening 66 against a closed end of the channel opening first section 76, thereby operating to lock placement of the blade in an open position. In this position the stop element 56 further acts in conjunction with the locking/release pin 18, by making contact with a portion of the blade butt 42 to thereby limit further upward open movement of the blade. FIG. 6C illustrates the position of the locking/release pin 18 within the channel track openings 74 of the liners 26 and 28 when locking/release pin 18 is manually actuated to overcome the spring bias and displace the pin from the channel opening first section 76, causing the pin to travel along the second section 78 with the blade as the blade rotated/pivoted counterclockwise relative to the liners into a closed position where the locking/release pin 18 is biased by the spring 98 into releasable engagement with the channel section third section 80. In this manner, the locking mechanism operates to ensure locked engagement of the first member in an open position, and provide releasable registered engagement of the first member in a closed position. FIG. 7 illustrates the folding knife 10 in a closed position with the blade 14 disposed within the handle 16.

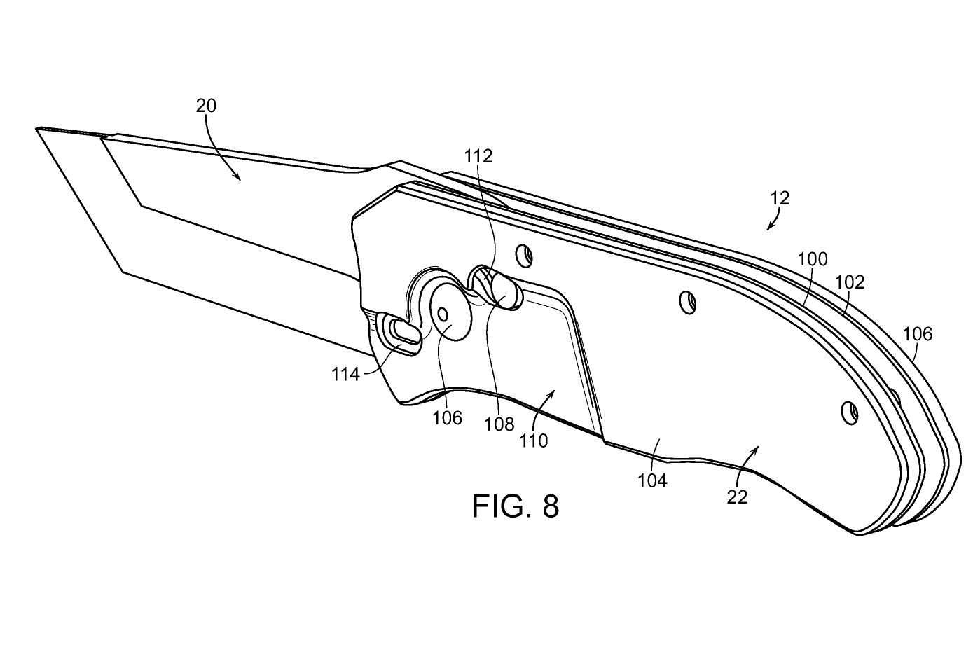

FIG. 8 illustrates the second example folding assembly and locking mechanism embodied in the form of a folding knife 12 in an open position comprising the blade 20 and the handle 22. As with the first folding knife, the second folding knife comprises liners 100 and 102 sandwiching the blade 22, and grips 104 and 106 positioned over opposite surfaces of the respective liners 100 and 102. The configuration of the blade 22, liners 100, 102, grips 104, 106, main pin 106, and the locking/release pin 106 are generally similar to that described above for the first example knife, with some differences that will be further described below to accommodate assisted activation of the blade from the closed to the opened and locked position, and wherein the liners and the release/locking pin are components of the folding assembly locking mechanism. Notably, the grip 104 comprises a recessed section 110 that includes, in addition to an opening 112 disposed above the main or pivot pin for accessing the locking/release pin 108 when the blade is in an open and locked position, an opening 114 disposed below and on an opposite side of the main pin for accessing the locking/release pin 108 when the blade is in a closed and locked position. Unlike the first example folding knife, when the second example folding knife 12 is in a closed position it is locked into such closed position by the locking mechanism. Thus, the opening 114 is useful for accessing the locking/release pin 108 to thereby release the blade so it can be automatically moved by an assist mechanism into the opened and locked position.

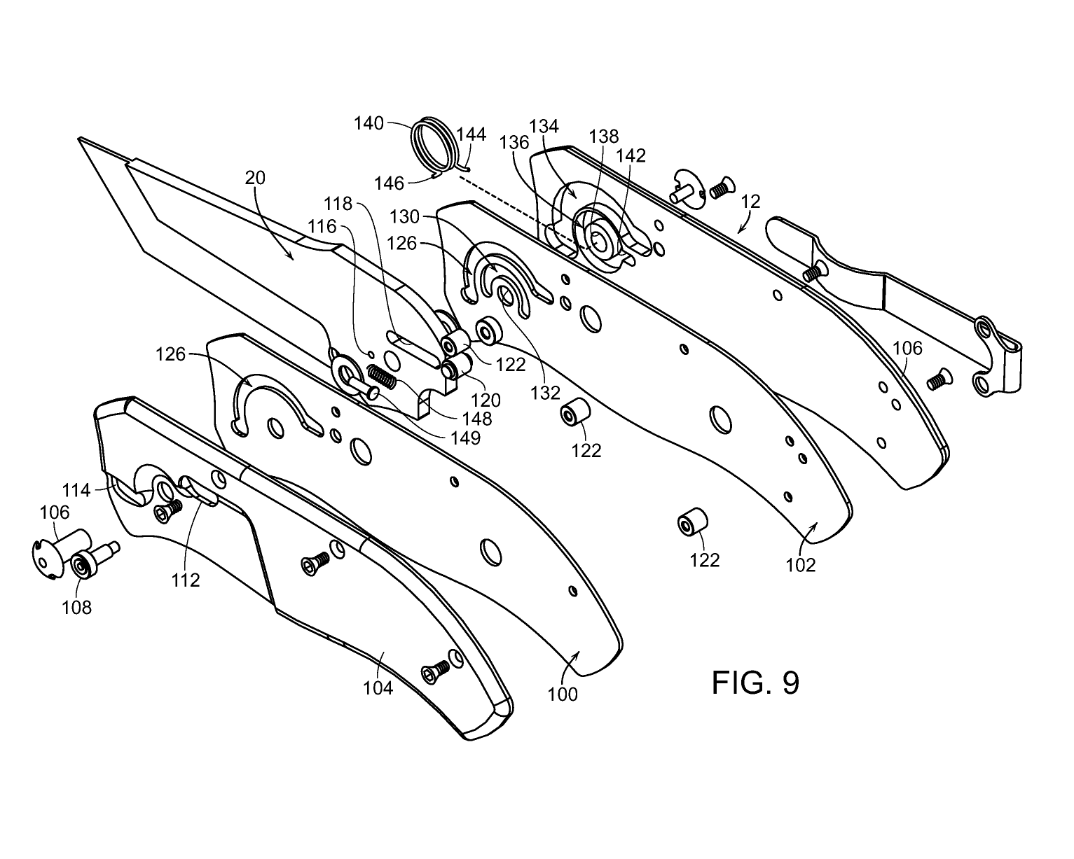

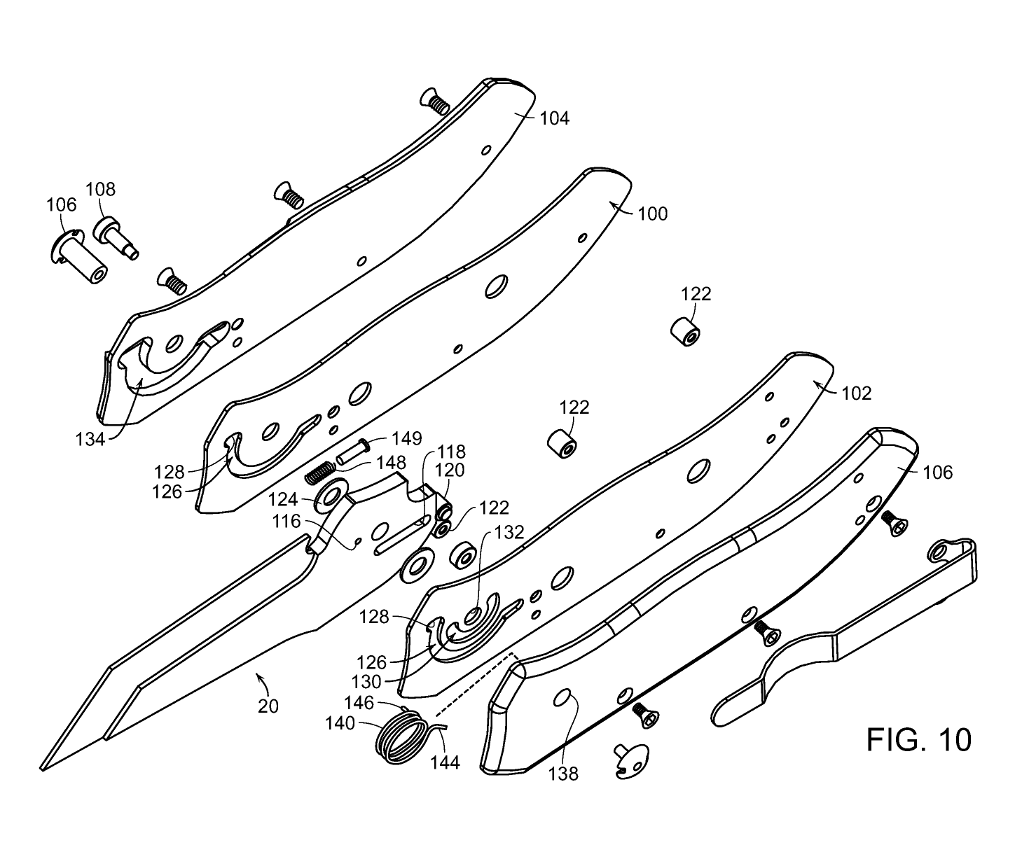

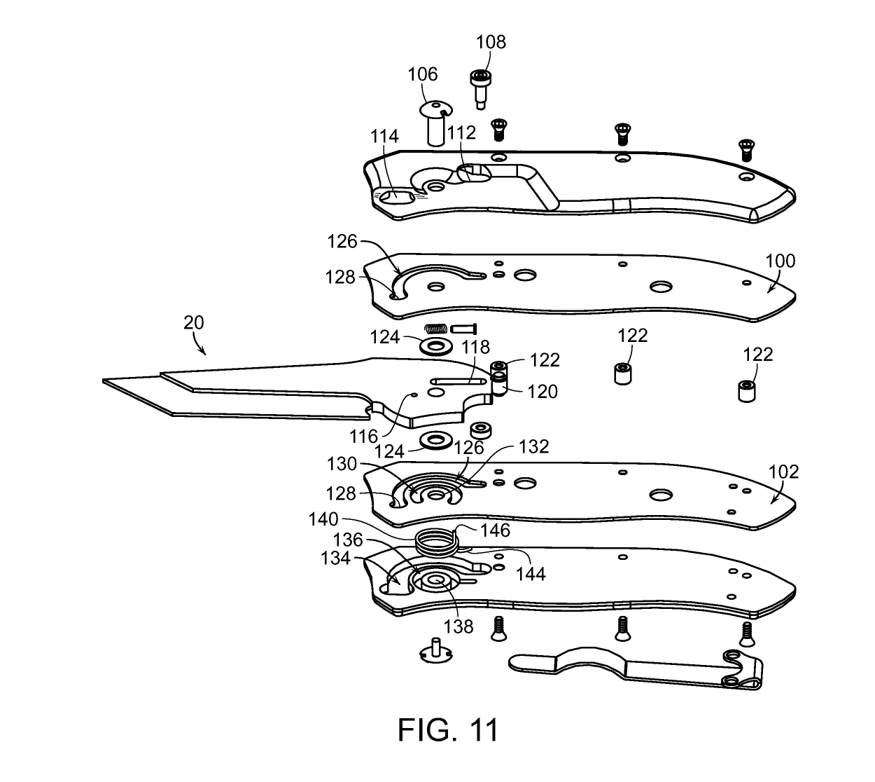

FIGS. 9 to 11 illustrate the second example knife 12 as disclosed herein in a disassembled state showing the various elements and members used to construct the knife 12 and locking mechanism, including those described above and illustrated in FIG. 2. The blade 20 is constructed from the same material, and has the same general configuration and features, as described above for the first example knife. Unlike the first example knife, the blade includes an opening 116 adjacent the elongate slot opening 118 that is sized and positioned to accommodate placement of a portion of an assist element therein. The stop element 120, spacers 122 and washers 124 are the same as those described above for the first example knife and are interposed between the liners 100 and 102 in the same manner. The liners 100 and 102 are part of the locking mechanism and each comprise channel track openings 126 disposed therethrough that are configured similar to the channel openings described above for the first example knife, with the exception that the channel opening third section 128 for use with the second example knife is more elongate in configuration to provide a locked engagement in a close position. The channel opening third section 128 is constructed having a more elongate configuration for the purpose of not simply registering with the locking/release pin 108 when the blade is placed into a closed position, but to engage and receive the entire locking/release pin 108 therein through the bias force acting on it (as described above for the first example knife) by the spring 148 and guide pin 149 disposed in the blade elongate opening 118. In an example, each liner channel opening third section 128 may be configured to capture the same percent of the locking/release pin 108 diameter as described above for the first section of the channel openings for the first example knife. Also, each channel opening third section 128 may be constructed having a tapered configuration as disclosed above for the first second of the channel openings for the first example knife for the purpose of helping to guide engagement the locking/release pin 108 therein during placement of the knife into a closed position. The remaining features and construction of liner 100 is the same is as that disclosed above for the liners of the first example knife.

The liner 102, in addition to having the channel opening 126 with the third section as described above, further includes a second channel opening 130 that extends through the liner 102 and that exists between the main opening 132 and the channel opening 126. In an example, the second channel opening 130 has a semi-circular shape concentric around the main opening. The second channel opening 130 is provided to allow access of a portion of an assist element therethrough from a position adjacent an inside surface of the grip 106 that contains the assist element. In an example, the second channel opening may extend from about 120 to 270, 150 to 250, and approximately 180 degrees concentrically around the main opening to accommodate unhindered travel of a portion of an assist element therein that is attached to the blade in opening 116 during pivoting movement of the blade between open and locked and closed and locked positions.

The grips 104 and 106 are configured in the same general manner as that disclosed above for the first example knife except for the following differences. The grip 104, in addition having an opening 112 for providing manual, e.g., thumb contact, access to the locking/release pin 108 of the locking mechanism when the blade is in an open and locked position to thereby enable a user to move the locking/release pin 108 out of engagement with the channel section first section to unlock the blade, further includes the opening 114 for providing manual access to the locking/release pin 108 of the locking mechanism when the blade is in a closed and locked position. The openings 112 and 114 though the grip 104 correspond to sections of the recessed channel 134, disposed along a grip inside surface, that are aligned with the liner 100 channel opening 126 first and third sections. The openings 112 and 114 are configured having an elongate shape to accommodate travel of the locking/release pin 108 to each of the respective blade open and locked and closed and locked positions.

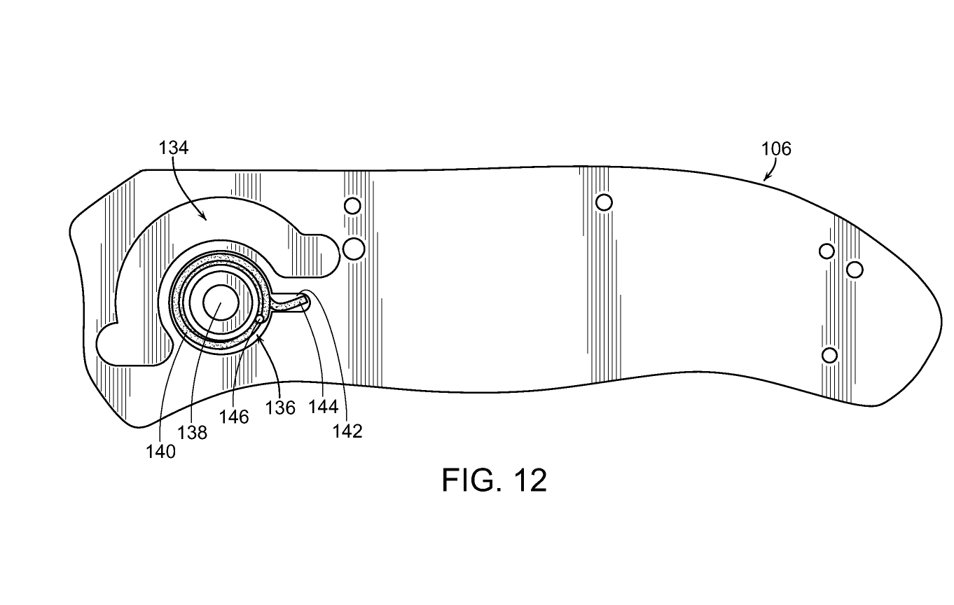

The grip 106, in addition to comprising the recessed channel 134, further includes a second recessed channel 136 that is interposed between the main opening 138 and the recessed channel 134. The second recessed channel 136 is configured to accommodate an assist element therein. In an example, the assist element is provided in the form of a coil spring 140 (as best illustrated in FIG. 12), and the second recessed channel is configured having a circular shape to accommodate placement of the spring therein. The particular size/force of the spring element that is used can and will vary depending on the particular end-use application. In an example, the spring element 140 may provide a spring force sufficient to automatically cause the blade to move from a closed to opened position by release of the locking/release pin 108 when in a closed position. In an example, the spring element provides a force of about 1 to 10 lbs when the blade is placed in a closed locked position.

In such example, the second recessed channel 136 includes an elongate section 142 extending radially therefrom for the purpose of accommodating and containing a first end 144 of the spring element 140 to fix its placement therein. In such example, the spring element 140 includes a second end 146 that projects axially outwardly from the spring element 140, which second spring end 146 is disposed through the liner 102 second recessed channel opening 130, and is disposed within the blade opening 116. Configured in this manner, the spring element operates to impose a clockwise directed biasing spring force onto the blade for the purpose of enabling the blade to move from a closed position to an open and locked position by manual release of the locking/release pin 108 when accessed through grip 104 opening 114.

The folding knife 14 and locking mechanism is assembled by combining the above-described elements together as illustrated in FIGS. 9 to 11, and in the same general fashion as described above with respect to the first example folding knife 10. A notable difference for the second example knife 12 being the attachment of the coil spring second end 146 into the blade opening 116 and through the liner 102, and fixing placement of the spring 120 within the second recessed channel 136 of the grip 106 in a manner enabling the spring to provide a desired biasing force to automatically, i.e., without further user intervention, move the blade to an opened and locked position when released from a closed and locked position.

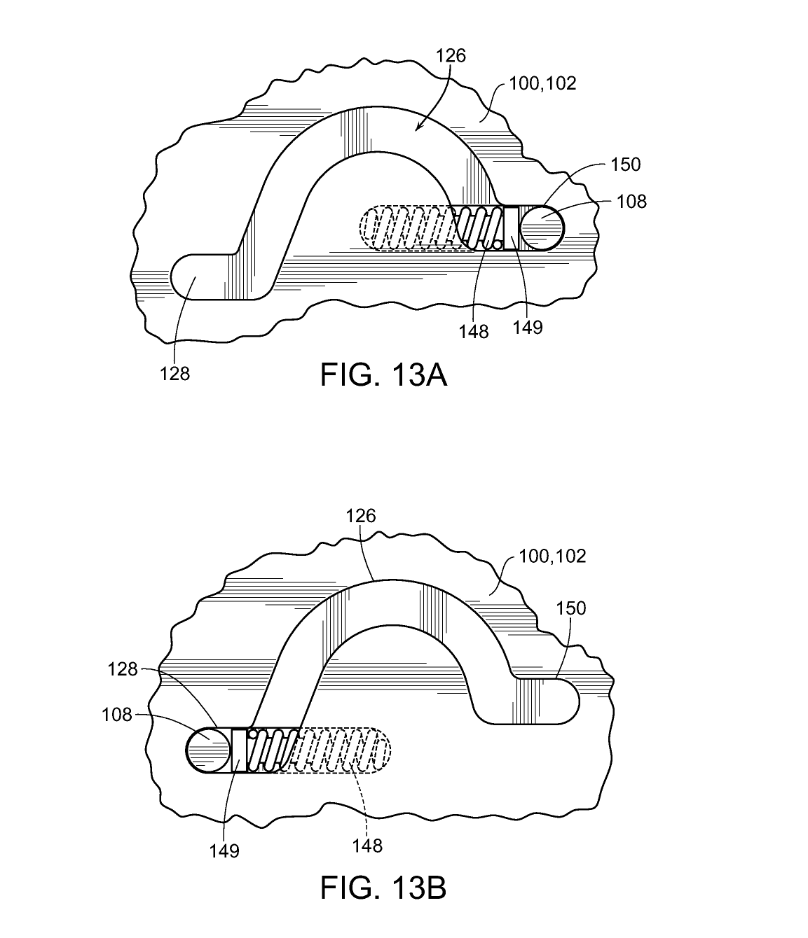

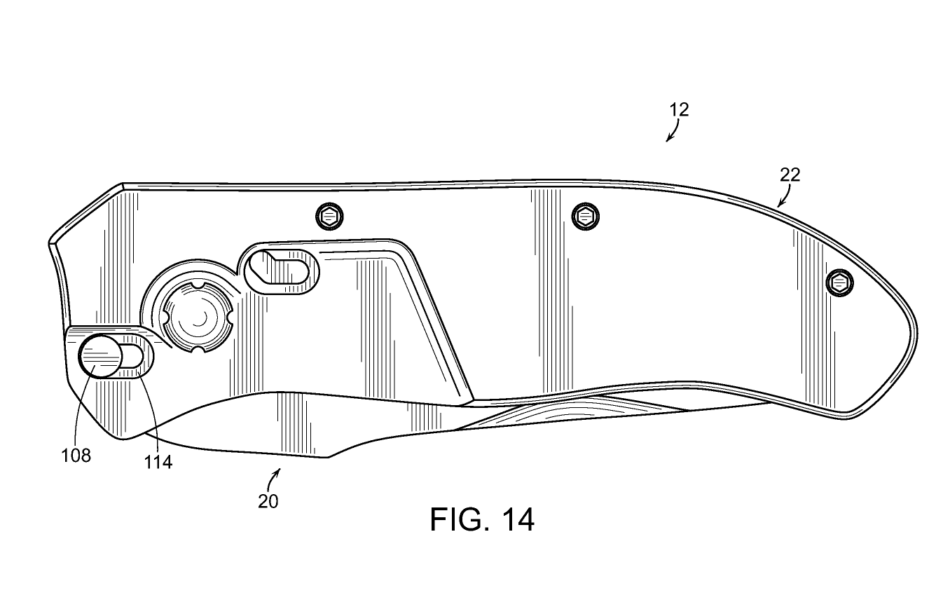

FIGS. 13A and 13B illustrate the position of the locking/release pin 108 within the channel track openings 126 of the liners 100 and 102, i.e., the locking mechanism components, when the blade is in a locked open position and in a locked closed position for the second example folding knife. Specifically, FIG. 13A illustrates the position of the locking/release pin 108 within the channel openings 126 of the liners 100 and 102 as being biased by the spring 148 and guide pin 149 disposed in the blade elongated opening 118 against a closed end of the channel opening first section 150, thereby operating to lock placement of the blade in an open position, and whereby the stop element 120 further acts in conjunction with the pin 108, by making contact with a portion of the blade butt to limit further upward open movement of the blade. FIG. 13B illustrates the position of the locking/release pin 108 within the channel openings 126 of the liners 100 and 102 when locking/release pin 108 is manually actuated to overcome the spring bias and displace the pin from the channel opening first section 150, causing the pin to move along the second section 126 with the blade as the blade rotated counterclockwise relative to the liners into a closed locked position where the locking/release pin 108 is biased by the spring 148 against a closed end of the channel opening third section 128, thereby operating to lock placement of the blade in a closed position. In this manner, the locking mechanism operates to ensure locked engagement of the first member in an open position, and ensure locked engagement of the first member in a closed position. FIG. 14 illustrates the folding knife 12 in a closed position with the blade 20 disposed within the handle 16 with the locking/release pin 108 accessible through the grip opening 114.

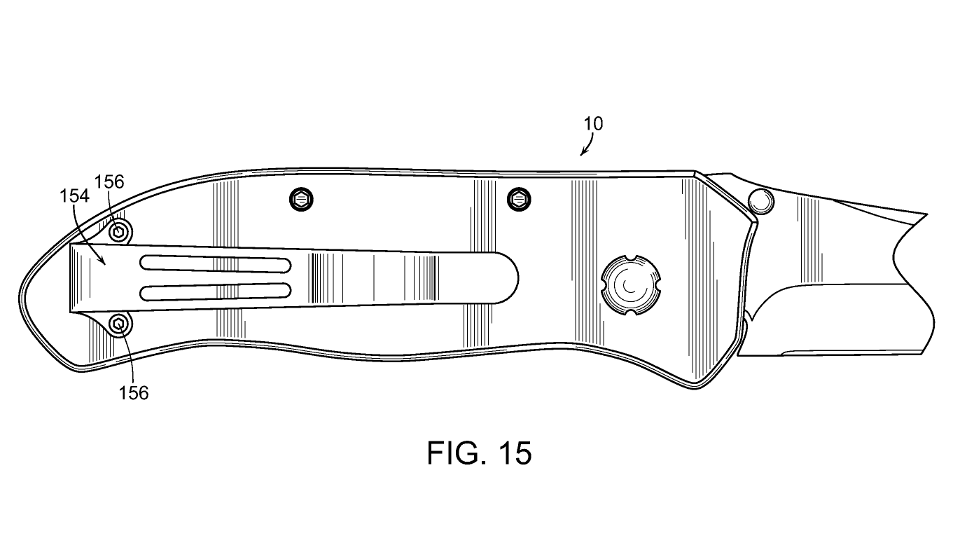

FIG. 15 illustrates a folding assembly as disclosed herein and embodied as the first example folding knife 10 comprising an optional attachment clip 154 for purpose of wearing or carrying the knife. In an example, such attachment clip 154 may be attached to the knife by one or more fasteners that extend into one or both of the grip and liner. In an example, the attachment clip 154 may be attached to the knife by screws 156 that extend though openings 158 in the grip 32 and engage threaded openings 160 in the liner 38. While the optional attachment clip has been described and illustrated for use with the first example knife, it is to be understood that such attachment clip can equally be used with the second example knife.

Folding assemblies comprising locking mechanisms as disclosed herein provide an improvement over conventional locking mechanisms as used with folding assemblies in that the locking mechanisms as disclosed herein are specially constructed comprising a locking/release pin that is in double shear with two opposed metal liners, and further in conjunction with a stop element connected with the liners that operates to limit the upward opening motion or movement of the first member relative to the second member. Such locking mechanism as disclosed herein is not susceptible to the types of lock failures known to occur with folding assemblies, e.g., embodied in the form of folding knives, employing the conventional linerlock gate systems and the lockback rocker systems, thereby providing minimizing or eliminating lock failure to provide safe, reliable and improved folding assembly locking service life.

While folding assemblies comprising locking mechanisms as disclosed herein have been described with reference to a particular embodiment in the form of folding knives comprising a particular type of first and second member, it is to be understood that folding assemblies comprising locking mechanisms as disclosed herein are intended to be embodied in folding mechanisms having first and second members that may be configured differently as called for by a particular end-use application, which other different configurations are fully intended to be within the scope and spirit of the concepts disclosed herein. Accordingly, it is to be understood that the locking mechanism as disposed herein is intended for with all such alternative folding member end-use embodiments. Other modifications and variations of folding assemblies and locking mechanisms as disclosed herein will be apparent to those skilled in the art.

It is, therefore, to be understood that within the scope of the present disclosure that such folding assemblies and locking mechanisms may be practiced otherwise than as specifically described, and although several embodiments have been described in detail for purposes of illustration, various modifications may be made without departing from the scope and spirit of the invention. Accordingly, the invention is not to be limited, except as by the appended claims.

What is claimed is:

1. A folding assembly, comprising:
a handle;
a tool pivotally connected to the handle and movable between a closed position in which the tool extends along the handle and an open position in which a free end of the tool extends away from the handle;
a manually actuated locking pin extending axially through an elongated slot formed in the tool and into a track of the handle, wherein a portion of the locking pin travels a length of the track as the tool is moved between the closed and open positions; and
a spring disposed within the elongated slot of the tool for biasing the locking pin away from the free end of the tool.

2. The assembly of claim 1, wherein the spring is disposed within the slot generally transverse to the locking pin.

3. The assembly of claim 2, wherein the spring comprises a compression spring.

4. The assembly of claim 2, including a guide pin disposed within the slot and biased by the spring against the locking pin.

5. The assembly of claim 1, wherein an end of the locking pin extends from an aperture of the handle when the locking pin is moved to a locking position in the track.

6. The assembly of claim 5, wherein the handle includes an external recess adjacent to the aperture through which the locking pin extends.

7. The assembly of claim 1, wherein the handle comprises first and second grips and first and second liners disposed between the grips in spaced relation on opposite sides of the tool when in the closed position.

8. The assembly of claim 7, wherein the track is formed in at least one of the first and second grips and at least one of the first and second liners.

9. The assembly of claim 1, wherein the track is generally disposed radially from a pivotal connection point of the tool and handle, and wherein a first end of the track comprises a first locked position when the locking pin is disposed therein.

10. The assembly of claim 9, wherein a generally opposite second end of the track comprises a second locked position when the locking pin is disposed therein.

11. The assembly of claim 10, wherein the locking pin locks the tool in the open position when in the first locked position, and locks the tool in the closed position when in the second locked position.

12. The assembly of claim 1, including a mechanism for assisting in the opening or closing of the tool.

13. The assembly of claim 12, wherein the assisting mechanism comprises a spring fixed at one end to the tool and at another end to the handle.

14. The assembly of claim 13, including an internal recess formed in a grip of the handle into which is disposed a coil spring, having one end connected to the handle and having an opposite end extending through a channel formed in a liner of the handle and connected to the tool.

15. The assembly of claim 1, wherein the folding assembly comprises a folding knife, and the tool comprises a blade.

16. A folding assembly, comprising:
a handle;
a tool pivotally connected to the handle and movable between a closed position in which the tool extends along the handle and an open position in which a free end of the tool extends away from the handle;
a manually actuated locking pin extending axially through an elongated slot formed in the tool and into a track of the handle, wherein a portion of the locking pin travels a length of the track as the tool is moved between the closed and open positions; and
a compression spring and a guide pin disposed within the elongated slot of the tool generally transverse to the locking so as to bias the locking pin away from the free end of the tool;
wherein an end of the locking extends from an aperture of the handle when the locking pin is disposed at a locking position in the track.

17. The assembly of claim 16, wherein the handle includes an external recess adjacent to the aperture through which the locking pin extends.

18. The assembly of claim 16, wherein the handle comprises first and second grips and first and second liners disposed between the grips in spaced relation on opposite sides of the tool when in the closed position.

19. The assembly of claim 18, wherein the track is formed in at least one of the first and second grips and at least one of the first and second liners.

20. The assembly of claim 16, wherein the track is generally disposed radially from a pivotal connection point of the tool and handle, and wherein a first end of the track comprises a first locked position when the locking pin is disposed therein.

21. The assembly of claim 20, wherein a generally opposite second end of the track comprises a second locked position when the locking pin is disposed therein.

22. The assembly of claim 21, wherein the locking pin locks the tool in the open position when in the first locked position, and locks the tool in the closed position when in the second locked position.

23. The assembly of claim 16, including a mechanism for assisting in the opening or closing of the tool.

24. The assembly of claim 23, wherein the assisting mechanism comprises a spring fixed at one end to the tool and at another end to the handle.

25. The assembly of claim 24, including an internal recess formed in a grip of the handle into which is disposed a coil spring, having one end connected to the handle and having an opposite end extending through a channel formed in a liner of the handle and connected to the tool.

26. The assembly of claim 16, wherein the folding assembly comprises a folding knife, and the tool comprises a blade.
